(19) United States
(12) Patent Application Publication
(10) Pub. No.: US 2005/0217169 A1
(43) Pub. Date: Oct. 6, 2005

(54) Mobile designed to come into contact with another mobile or fixed component

(76) Inventor: Pierre Kunz, Echenevex (FR)

Correspondence Address: OSTROLENK FABER GERB & SOFFEN, 1180 AVENUE OF THE AMERICAS, NEW YORK, NY, 100368403, US

(21) Appl. No.: 11/087,461

(22) Filed: Mar. 23, 2005

(30) Foreign Application Priority Data
Mar. 25, 2004 (CH) 00502/04

(51) Int. Cl. H04B 7/15; A01G 1/00

(52) U.S. Cl. 47/33

(57) ABSTRACT

The mobile comprises a hub (1) rotating on its axis and a transmission or rolling rim (3) designed to come into contact with a mobile or fixed component, the hub (1) and the transmission or rolling rim (3) being linked by leaves (2) arranged to allow for the relative movement of the transmission or rolling rim (3) in relation to the hub (1) under the spring action of the leaves (2).

The object of the invention is a mobile designed to come into contact with another mobile or fixed component.

In clock and watch-making, for example, when an additional mobile is added to an existing mechanism, the staff of one mobile often has to pass through the entire bottom plate to display, for example, an indication on the dial. This means that the staff of the mobile may encounter one or more existing components of the movement. Numerous complications then arise if the position of the vertical axis of the mobile passing through the entire bottom plate has to be changed. This problem has led the owner to propose a mobile that can be forced to move relative to its axis, in such a way as to avoid colliding with a staff or any other part of the movement. The force exerted on the mobile will consist in moving the axis of the said mobile, the central part of which will undergo a deformation, the circumference of the mobile being moved laterally. Thus, the owner has developed a mobile with a certain flexibility enabling it to undergo movements without changing a centre distance, without altering its function, and without changing its gear ratio.

Such a mobile is described in U.S. Pat. No. ______ (application Ser. No. 0385/03) in the name of the owner. It comprises a hub rotating on its axis, and a transmission or rolling zone designed to come into contact with a mobile or fixed component, a flexible zone able to undergo deformation being inserted between the hub and the transmission zone. The flexible zone is a deformable foam, or is made up of a series of leaves linking the hub to the transmission or rolling zone. The object of this invention is to propose a similar mobile made in one piece.

The mobile designed to come into contact with a mobile or fixed component according to the invention is characterised in that it comprises a hub rotating on an axis and a transmission or rolling rim designed to come into contact with the mobile or fixed component, the hub and the transmission or rolling rim being linked by leaves arranged to allow for the relative movement of the transmission or rolling rim in relation to the hub under the spring action of the leaves.

The leaves extend concentrically relative to the transmission and rolling rim, with radial play being provided between the hub and the rim.

There may be a bent section in the middle of the leaves allowing for the difference in elongation of the said leaves to be absorbed.

The hub may have openings placed opposite the bent sections of the leaves, the openings allowing the leaves to carry out their spring function without coming into contact with the hub or the rim.

The hub may have recesses in which studs integral to the transmission or rolling rim are positioned.

Play is usually provided between the recesses and the studs. The leaves and the studs are evenly arranged on the periphery of the circumference of the mobile.

In a preferred embodiment, the mobile has three spring leaves evenly arranged around its circumference, and three recesses are arranged to each receive a stud on the transmission or rolling rim, the recesses being evenly spaced around the circumference of the mobile, each of the studs being inserted between two leaves of the mobile. The transmission or rolling rim is a toothed wheel, a star wheel or a smooth wheel allowing for friction driving.

The mobile is preferably made of steel and coated with molybdenum disulphide.

An additional object of the invention is a production method for the mobile characterised in that it is made all in one piece without molecular discontinuity, by traditional machining, starting from a blank, by metal cutting, wire cutting, spark EDM, electroforming or swage cutting, or by micromoulding through exposure of UV-sensitive resin, galvanic deposition in micromoulds or galvanic coating on a substrate.

The drawing shows, as an example, an embodiment of a mobile according to the invention that can be offset relative to its axis, and set in motion in its offset position.

In the drawing:

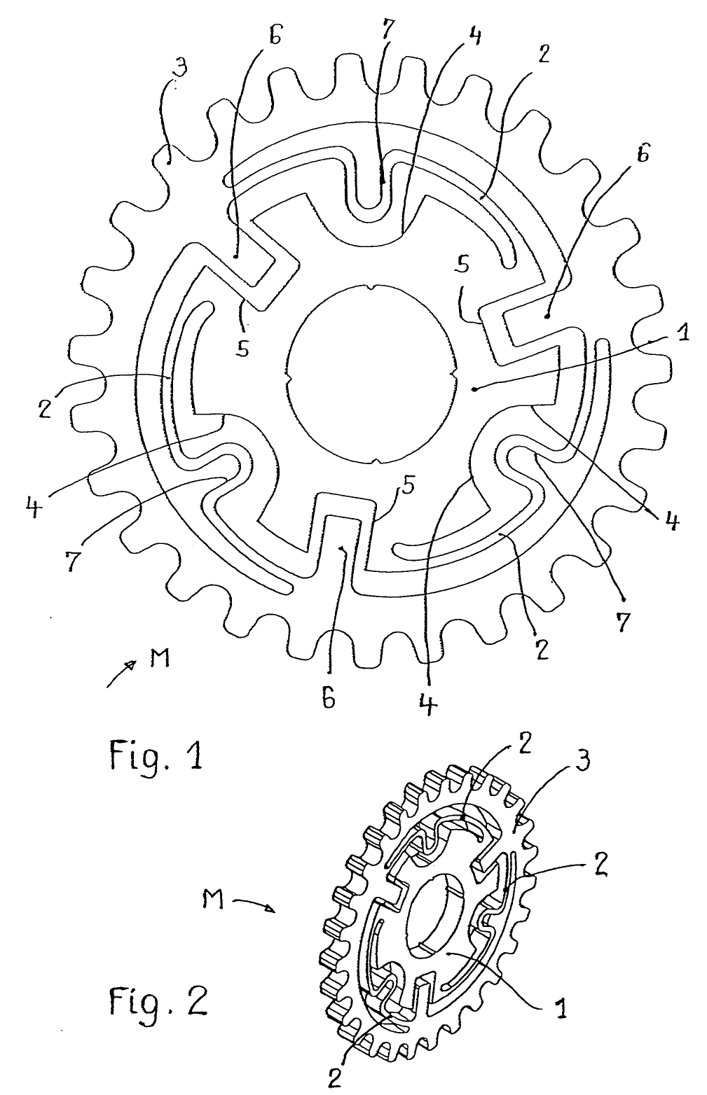

FIG. 1 is a top view of the mobile, and

FIG. 2 is a perspective view of the mobile in FIG. 1.

The mobile described with reference to FIGS. 1 and 2 has been developed for the clock and watch-making industry. Its application is not however limited to this specific field, and can be extended to general mechanics, and in particular to the automotive industry, aviation, micromechanics, machine tools, medicine and any technical field in which a mobile must be brought into contact with a fixed mechanical component or a mobile, by deformation of its structure corresponding to a movement of its centre of rotation.

Once in place, the mobile shown in the embodiment in FIGS. 1 and 2 allows for meshing with another mobile or any other sort of transmission whilst being offset from its axis of rotation.

The mobile M in FIG. 1 comprises a central part or hub 1 linked by means of flexible leaves 2 to a transmission or rolling rim 3. The transmission rim 3 is equipped, in the embodiment in FIGS. 1 and 2, with teeth allowing for the mobile M to mesh with another mobile. Alternatively, the transmission rim 3 may be a smooth rim allowing for friction driving or a star performing the function of a jumper.

The central section or hub 1 has openings 4 that allow the leaves 2 to deform freely, and recesses 5 designed to support studs 6 that are an integral part of the rim 3. The studs 6 have a guiding function and relay the transmission of the force exerted by the rim 3 in order to ensure the transmission of the movement, limit the deformation of the leaves 2, and thus eliminate the risk of breakage.

The leaves 2 are attached at regular intervals on either side of the hub 1 and the rim 3 respectively. They have in their middle a bent section 7 designed to absorb the differences in elongation of the leaves 2. The bent sections 7 will preferably be slightly thicker than the straight sections of the leaves 2, which allows for the stress to be distributed and the strength of the mobile increased.

As shown in the drawing, the mobile has three leaves 2 particularly spaced around its circumference and the rim 3 has three studs 6 evenly spaced and placed between the openings 4. Play is left between the studs 6 and the recesses 5 in such a way as to give the assembly a certain freedom of operation, the studs 6 only coming into contact with one or other of the lateral edges of the recesses 5 after the spring action of the leaves 2 has been exerted. The studs 6 are thus used to limit the spring action of the central sections 7 of the leaves 2, and thus prevent breakage. The straight sections of the leaves 2 are designed to absorb the offsetting of the rim 3 relative to the hub 1.

The mobile M that has just been described will preferably be made of phosphorus nickel or steel, and will be coated with molybdenum disulphide. The surfaces in contact during the operation of the mobile M, particularly the surfaces of the recesses 5 and the studs 6, will thus be able to slide more easily against each other and premature wear of the mobile will thus be limited.

With the mobile that has just been described, it is possible to force the circumference of the mobile to compensate for an insufficient distance between two centres without altering the transmission function and transmission ratio of the assembly.

This solution also allows for compensation for lesser problems encountered in clock and watch-making, such as radial run-out of mobiles or problems of butting between mobiles. Minor defects due to the positioning of the pivot holes of the various mobiles can also easily be corrected.

1. Mobile designed to come into contact with a mobile or fixed component, wherein it comprises a hub rotating on its axis, and a transmission or rolling rim designed to come into contact with the mobile or fixed component, the hub and the transmission or rolling rim being linked by leaves arranged to allow for the relative movement of the rim in relation to the hub under the spring action of the leaves.

2. Mobile according to claim 1, wherein the leaves extend concentrically relative to the transmission and rolling rim, with radial play provided between the hub and the rim.

3. Mobile according to claim 1, wherein there is a bent section in the middle of the leaves that allows for the difference in elongation of the said leaves to be absorbed.

4. Mobile according to claim 3, wherein the hub has openings placed opposite the bent sections of the leaves, the openings allowing the leaves to perform their spring function between the hub and the rim.

5. Mobile according to claim 1, wherein the hub has recesses in which studs integral to the transmission or rolling rim are positioned.

6. Mobile according to claim 5, wherein play is provided between the recesses and the studs.

7. Mobile according to claim 5, wherein the leaves and the studs are evenly arranged on the periphery of the circumference of the mobile (M).

8. Mobile according to claim 5, wherein three recesses, each receiving a stud on the transmission or rolling rim are evenly spaced on the circumference of the mobile.

9. Mobile according to claims 8, wherein each of the studs is inserted between two leaves.

10. Mobile according to claim 1, wherein it has three spring leaves evenly arranged on its circumference.

11. Mobile according to claim 1, wherein the transmission or rolling rim is a toothed wheel, a star wheel or a smooth wheel allowing for friction driving.

12. Mobile according to claim 1, wherein it is made of steel.

13. Mobile according to claim 1, wherein it is coated with molybdenum disulphide.

14. Mobile according to claim 1, wherein it is made in one piece.

15. Production method for the mobile according to claim 1, wherein it is made all in one piece without molecular discontinuity, by traditional machining starting with a blank, by metal cutting, wire cutting, wire EDM, electroforming, spark EDM or swage cutting, or by micromoulding through exposure of UV-sensitive resin, galvanic deposition in micromoulds or galvanic coating on a substrate.
